(19) United States
(12) Patent Application Publication
(10) Pub. No.: US 2022/0099351 A1
(43) Pub. Date: Mar. 31, 2022

(54) AIR DOOR DEVICE

(71) Applicant: NIDEC SANKYO CORPORATION, Nagano (JP)

(72) Inventor: Satoru YOKOE, Nagano (JP)

(73) Assignee: NIDEC SANKYO CORPORATION, Nagano (JP)

(21) Appl. No.: 17/486,939

(22) Filed: Sep. 28, 2021

(30) Foreign Application Priority Data
Sep. 30, 2020 (CN) 202022196428.1

(51) Int. Cl. F25D 17/06

(52) U.S. Cl. CPC F25D 17/062

(57) ABSTRACT

An air door device, which facilitates the threading and assembly operations of leads, and avoid the dielectric breakdown of a substrate due to the intrusion of water. The air door device includes: a frame, with an opening portion; a door panel, rotates to open and close the opening portion; a cover portion, assembled on the frame along a preset direction in the horizontal direction with an opening facing the frame; a motor, arranged in a storage space enclosed by the cover portion and the frame and is used for driving the door panel to rotate; a substrate, arranged in the storage space; and a first lead, connected with the substrate, the thickness direction of the substrate is consistent with the preset direction, the motor is closer to the opening than the substrate, and the first lead is led out from the surface of the substrate facing the opening.

### CROSS REFERENCE TO RELATED APPLICATION

This application claims the benefit of China Application No. 202022196428.1, filed Sep. 30, 2020. The entirety of the above-mentioned patent application is hereby incorporated by reference herein and made a part of this specification.

### BACKGROUND

### Field of the Invention

The embodiments of the present invention relates to an air door device.

### Description of the Related Documents

In refrigerators, freezers and the like, air door devices are usually arranged in air flow paths from cold air supply sources to refrigeration spaces to control the amount of cold air sent to the refrigeration spaces.

The above-mentioned air door device usually includes: a frame, wherein the frame is provided with an opening portion; a door panel, wherein the door panel can rotate to open and close the opening portion; a cover portion, wherein the cover portion is assembled on the frame along a horizontal direction with an opening facing the frame; a motor, wherein the motor is arranged in a storage space enclosed by the cover portion and the frame and is used for driving the door panel to rotate; a substrate, wherein the substrate is arranged in the storage space and is closer to the opening side of the cover portion than the motor; and a lead, wherein the lead is connected with the substrate.

However, in the above-mentioned air door device, if a single-sided substrate is used as the substrate, it is necessary to arrange the lead on the side of the substrate facing the bottom surface of the cover portion. Therefore, it is necessary to assemble the motor, the substrate and the lead in the cover portion while considering the lead, and it is difficult to thread and assemble the lead.

In addition, in the above-mentioned air door device, since the substrate is located on the opening side of the cover portion, that is, at the boundary between the cover portion and the frame, condensed water generated in refrigerators, freezers and the like easily permeates into the above-mentioned storage device through the gap between the cover portion and the frame to reach the substrate, so that the substrate may undergo dielectric breakdown due to the intrusion of water.

### SUMMARY

The embodiment of the present invention is in view of the above-mentioned problems, and aims to provide an air door device, which facilitates the threading and assembly operations of leads, and helps to avoid the dielectric breakdown of a substrate due to the intrusion of water.

In order to achieve the above-mentioned purpose, the embodiment of the present invention provides an air door device, including: a frame, wherein the frame is provided with an opening portion; a door panel, wherein the door panel can rotate to open and close the opening portion; a cover portion, wherein the cover portion is assembled on the frame along a preset direction in the horizontal direction with an opening facing the frame; a motor, wherein the motor is arranged in a storage space enclosed by the cover portion and the frame and is used for driving the door panel to rotate; a substrate, wherein the substrate is arranged in the storage space; and a first lead, wherein the first lead is connected with the substrate, the thickness direction of the substrate is consistent with the preset direction, the motor is closer to the opening than the substrate, and the first lead is led out from the surface of the substrate facing the opening.

According to the air door device of the embodiment of the present invention, the thickness direction of the substrate is consistent with the preset direction in the horizontal direction, the motor is closer to the opening than the substrate, and the first lead is led out from the surface of the substrate facing the opening (that is, the surface facing the frame). Therefore, the first lead is easily threaded, and the first lead can be threaded after the motor, the substrate and the first lead are assembled in the cover portion, so the assembly operation is easy. Furthermore, the creepage distance can be increased to avoid water from intruding into the storage space through the gap between the cover portion and the frame to reach the substrate, resulting in the dielectric breakdown of the substrate.

In addition, in the air door device of the embodiment of the present invention, preferably, the first lead is led out from the substrate to the outside of the storage space through an open pore of the cover portion, and the open pore is arranged at a position beyond an upper wall of the cover portion.

According to the air door device of the embodiment of the present invention, the first lead is led out from the substrate to the outside of the storage space through the open pore of the cover portion, and the open pore is arranged at the position beyond the upper wall of the cover portion. Therefore, it is conducive to preventing water from intruding into the storage space from the open pore of the cover portion along the first lead to reach the substrate, resulting in the dielectric breakdown of the substrate.

In addition, in the air door device of the embodiment of the present invention, preferably, the air door device includes a second lead, and the second lead is connected with the terminal of the motor and is led out from the motor to the outside of the storage space through the open pore.

According to the air door device of the embodiment of the present invention, the air door device includes the second lead, and the second lead is connected with the terminal of the motor and is led out from the motor to the outside of the storage space through the open pore. Therefore, it is conducive to preventing water from intruding into the storage space from the open pore of the cover portion along the second lead, resulting in the dielectric breakdown of the substrate.

In addition, in the air door device of the embodiment of the present invention, preferably, the cover portion includes: a bottom wall, wherein the bottom wall is opposite to the frame at an interval on one side away from the opening in the preset direction; the upper wall, wherein the upper wall extends from the bottom wall toward the frame; and a side wall, wherein the side wall extends from the bottom wall toward the frame, the side wall is provided with the open pore, one of the upper wall and the side wall is provided with a shielding portion, the shielding portion is provided with a protrusion portion protruding along the horizontal direction from the vicinity right above the open pore, or is further provided with a bending portion extending downward from the front end of the protrusion portion.

According to the air door device of the embodiment of the present invention, one of the upper wall and the side wall is provided with the shielding portion, and the shielding portion is provided with the protrusion portion protruding along the horizontal direction from the vicinity right above the open pore. Therefore, the shielding portion can be used for inhibiting water from contacting the open pore of the cover portion, thereby further reducing the possibility of water intruding into the storage space through the open pore of the cover portion to result in the dielectric breakdown of the substrate; and in particular, if the shielding portion is further provided with the bending portion extending downward from the front end of the protrusion portion, the bending portion can be used for further inhibiting water from contacting the open pore of the cover portion, and the bending portion can also be used for limiting the lead-out direction of the first lead and the second lead to avoid the scattering of the first lead and the second lead to affect the operation.

In addition, in the air door device of the embodiment of the present invention, preferably, the upper wall is provided with the shielding portion, and the open pore is arranged at the upper end of the side wall.

According to the air door device of the embodiment of the present invention, the upper wall is provided with the shielding portion, and the open pore is arranged at the upper end of the side wall. Therefore, the possibility of water intruding into the storage space through the open pore of the cover portion to result in the dielectric breakdown of the substrate can be further reduced.

In addition, in the air door device of the embodiment of the present invention, preferably, the side wall is provided with a step portion, and the step portion protrudes along the horizontal direction in the vicinity direct below the open pore.

According to the air door device of the embodiment of the present invention, the side wall is provided with the step portion, and the step portion protrudes along the horizontal direction in the vicinity direct below the open pore. Therefore, the step portion can be used for limiting the lead-out direction of the first lead and the second lead to avoid the scattering of the first lead and the second lead to affect the operation.

In addition, in the air door device of the embodiment of the present invention, preferably, the air door device includes: a heater, wherein the heater is arranged on the periphery of the opening portion or on the door panel; and a third lead, wherein the third lead is connected with the heater and is led out from the heater to the step portion to converge with the first lead and the second lead, and then is led out together with the first lead and the second lead.

The air door device according to the embodiment of the present invention includes: the heater, wherein the heater is arranged on the periphery of the opening portion or on the door panel; and the third lead, wherein the third lead is connected with the heater and is led out from the heater to the step portion to converge with the first lead and the second lead, and then is led out together with the first lead and the second lead. Therefore, the lead-out direction of the first lead, the second lead and the third lead can be limited by the step portion to avoid the scattering of the first lead, the second and the third lead to affect the operation.

In addition, in the air door device of the embodiment of the present invention, preferably, the frame is provided with a frame main body and a separation portion, the frame main body is provided with the opening portion, the separation portion is located between the frame main body and the cover portion and encloses the storage space together with the cover portion, a guide groove is arranged on the outer surface of the separation portion, and the third lead is guided from the heater to the step portion through the guide groove.

According to the air door device of the embodiment of the present invention, the frame is provided with the frame main body and the separation portion, the frame main body is provided with the opening portion, the separation portion is located between the frame main body and the cover portion and encloses the storage space together with the cover portion, the guide groove is arranged on the outer surface of the separation portion, and the third lead is guided from the heater to the step portion through the guide groove. Therefore, the interference of the third lead on the rotation of the door panel can be avoided.

In addition, in the air door device of the embodiment of the present invention, preferably, the substrate is arranged on the upper wall side of the cover portion.

According to the air door device of the embodiment of the present invention, the substrate is arranged on the upper wall side of the cover portion. Therefore, even if water permeates into the storage space from the gap between the cover portion and the frame, it is difficult to reach the substrate, thereby avoiding the phenomenon that the water reaches the substrate to result in the dielectric breakdown of the substrate.

In addition, in the air door device of the embodiment of the present invention, preferably, the substrate is a single-sided substrate.

According to the air door device of the embodiment of the present invention, the substrate is the single-sided substrate. Therefore, it is conducive to reducing the manufacturing cost.

In addition, in the air door device of the embodiment of the present invention, preferably, the motor is located between the substrate and the side wall.

According to the air door device of the embodiment of the present invention, the motor is located between the substrate and the side wall. Therefore, the first lead is not easily shielded by the motor, and it is easier to thread the first lead.

In addition, in the air door device of the embodiment of the present invention, preferably, the first lead is welded on the surface of the substrate facing the opening.

In addition, in the air door device of the embodiment of the present invention, preferably, the air door device includes: a gear transmission mechanism, wherein the gear transmission mechanism transmits the driving force of the motor to the door panel and is closer to the opening than the substrate; a switch, wherein the switch is installed on the surface of the substrate facing the opening; and a switching mechanism, wherein the switching mechanism is driven by a gear in the gear transmission mechanism to switch the on-off state of the switch.

### (The Effect of the Embodiments of the Present Invention)

According to the embodiment of the present invention, the thickness direction of the substrate is consistent with the preset direction in the horizontal direction, the motor is closer to the opening than the substrate, and the first lead is led out from the surface of the substrate facing the opening (that is, the surface facing the frame). Therefore, the first lead is easily threaded, and the first lead can be threaded after the motor, the substrate and the first lead are assembled in the cover portion, so the assembly operation is easy. Furthermore, the creepage distance can be increased to avoid water from intruding into the storage space through the gap between the cover portion and the frame to reach the substrate, resulting in the dielectric breakdown of the substrate.

### BRIEF DESCRIPTION OF THE DRAWINGS

FIG. 1 is a three-dimensional diagram schematically showing an air door device according to an embodiment of the present invention.

FIG. 2 is another three-dimensional diagram schematically showing the air door device according to the embodiment of the present invention.

FIG. 3 is another three-dimensional diagram schematically showing the air door device according to the embodiment of the present invention.

FIG. 4 is a top view schematically showing the air door device according to the embodiment of the present invention.

FIG. 5 is a cross-sectional view schematically showing the air door device according to the embodiment of the present invention.

FIG. 6 is a three-dimensional diagram schematically showing some components of the air door device according to the embodiment of the present invention.

FIG. 7 is a side view schematically showing some components of the air door device according to the embodiment of the present invention.

FIG. 8 is another three-dimensional diagram schematically showing some components of the air door device according to the embodiment of the present invention

### DETAILED DESCRIPTION

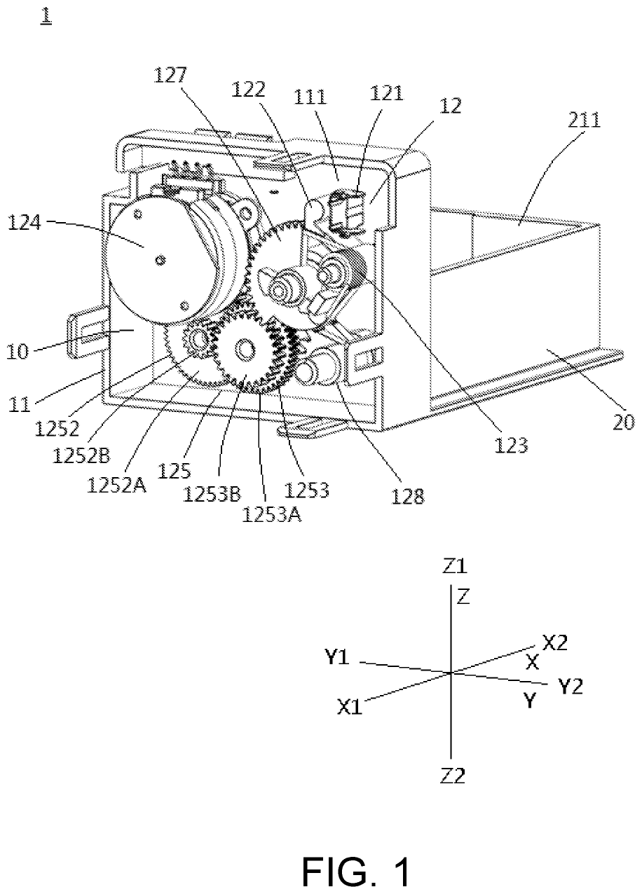

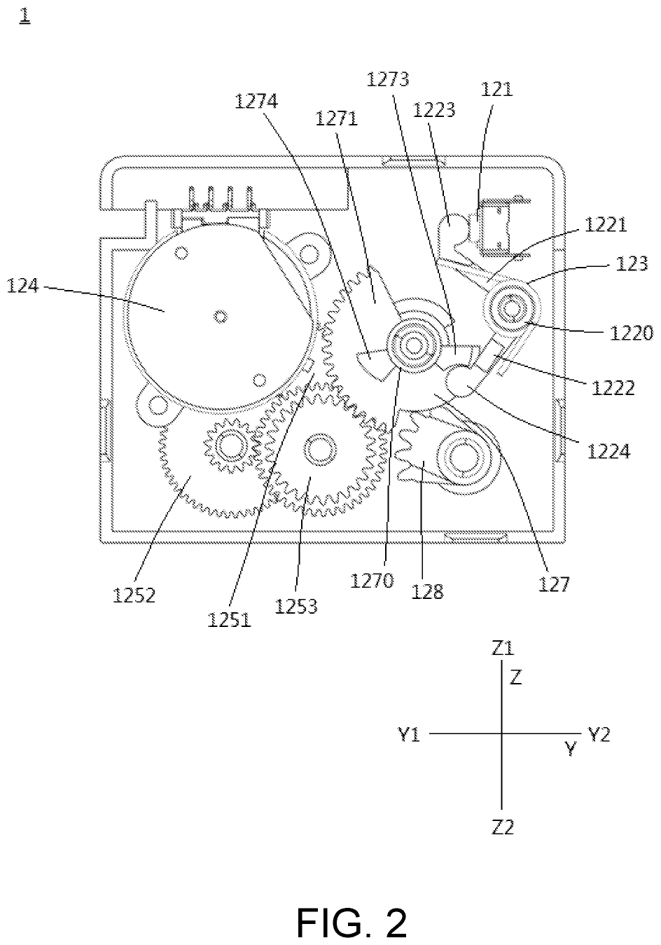

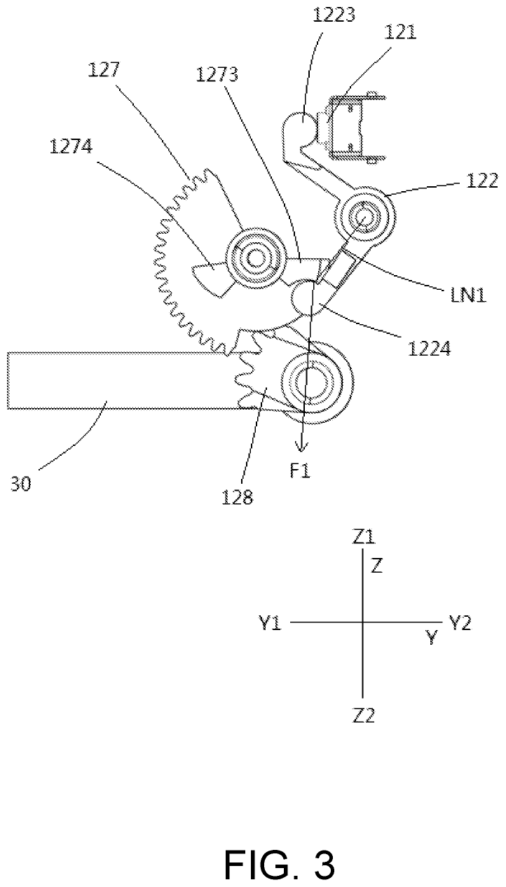

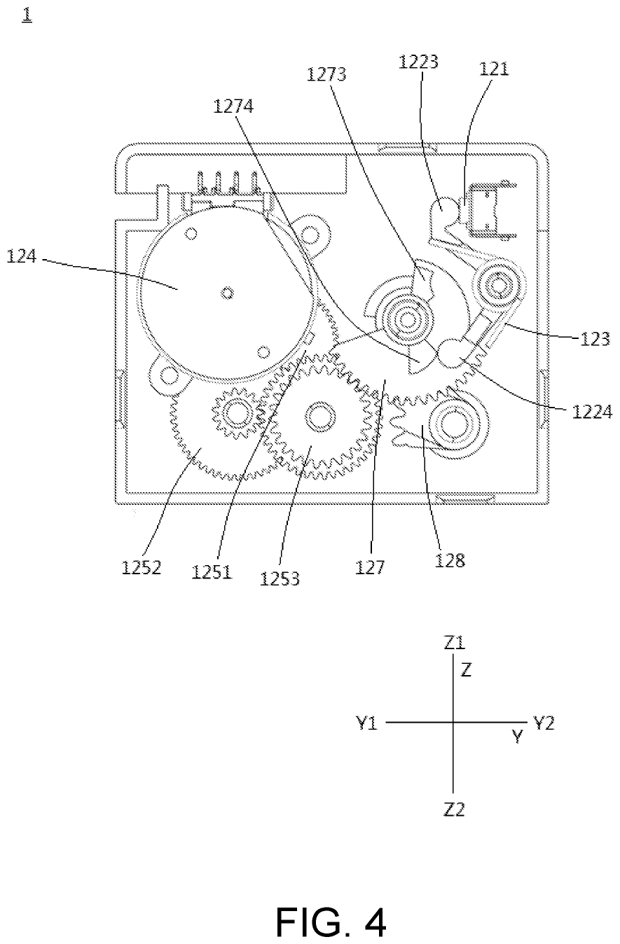

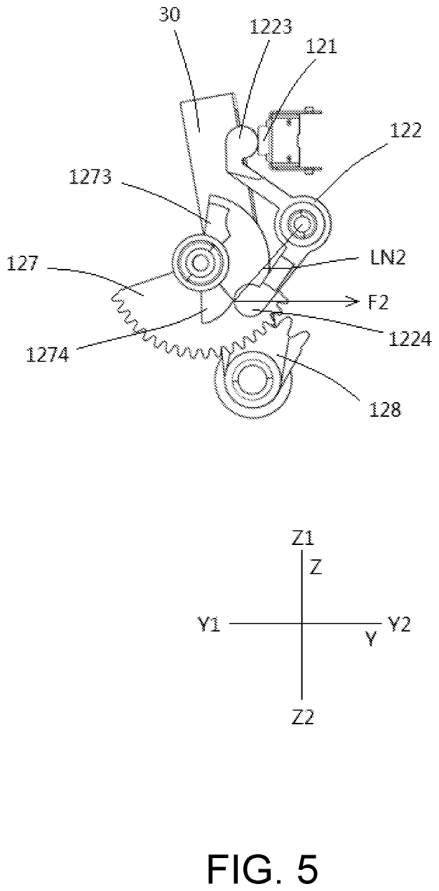

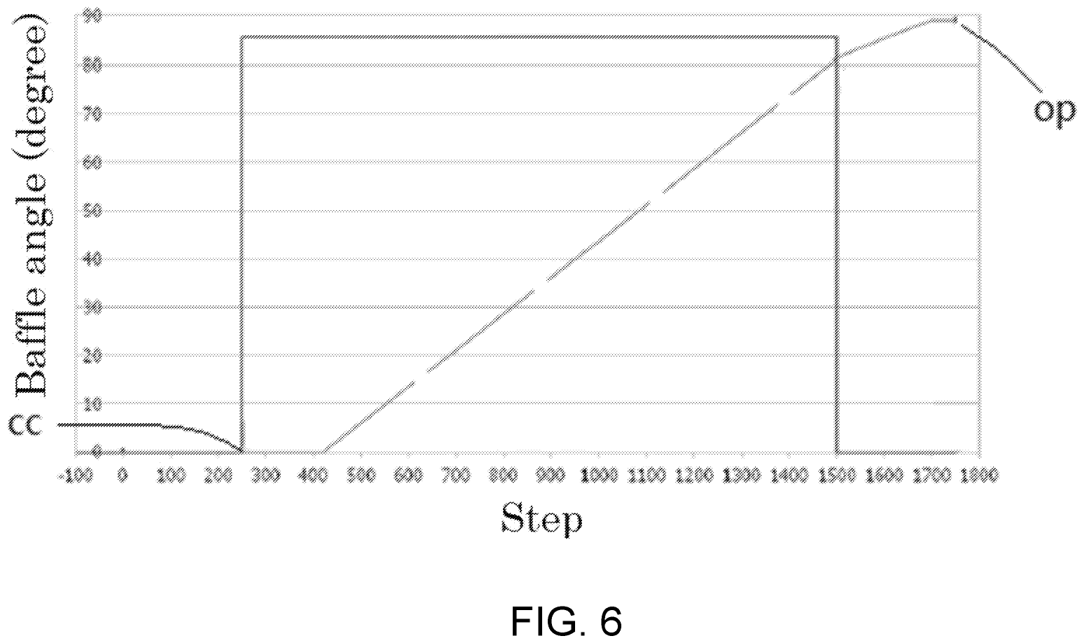

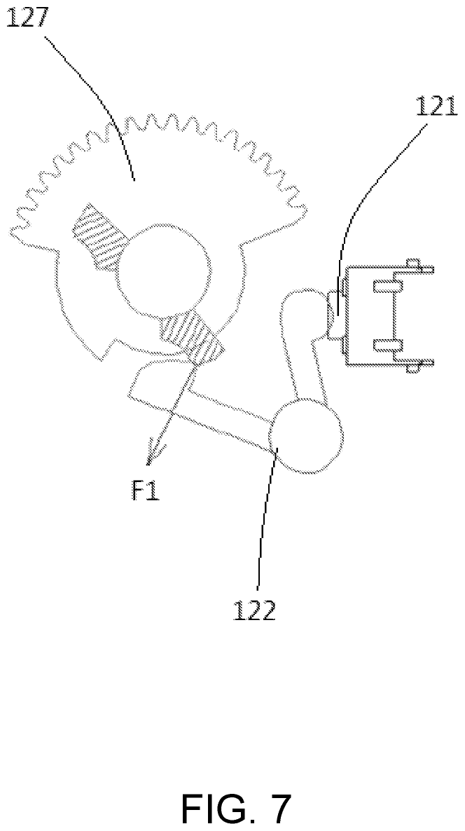

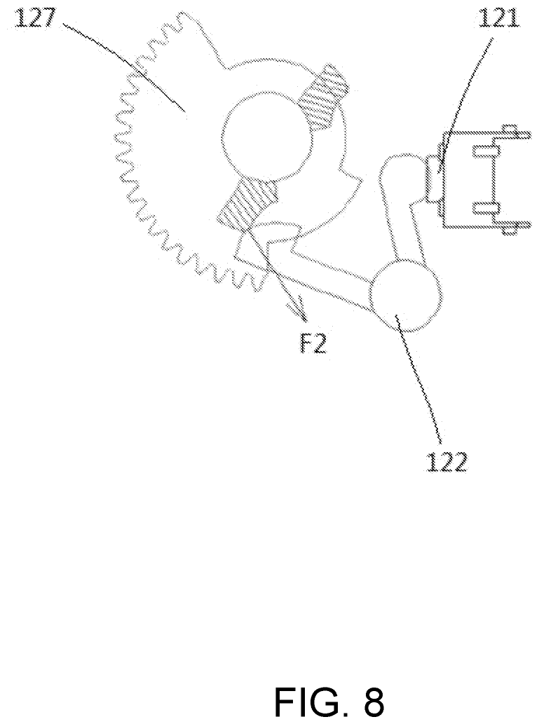

Hereinafter, an air door device according to an embodiment of the present invention will be described in combination with FIG. 1 to FIG. 8, wherein FIG. 1 is a three-dimensional diagram schematically showing the air door device according to the embodiment of the present invention, FIG. 2 is another three-dimensional diagram schematically showing the air door device according to the embodiment of the present invention, FIG. 3 is another three-dimensional diagram schematically showing the air door device according to the embodiment of the present invention, FIG. 4 is a top view schematically showing the air door device according to the embodiment of the present invention, FIG. 5 is a cross-sectional view schematically showing the air door device according to the embodiment of the present invention, FIG. 6 is a three-dimensional diagram schematically showing some components of the air door device according to the embodiment of the present invention, FIG. 7 is a side view schematically showing some components of the air door device according to the embodiment of the present invention, and FIG. 8 is another three-dimensional diagram schematically showing some components of the air door device according to the embodiment of the present invention.

Here, for the convenience of description, three directions orthogonal to each other are set as an X direction, a Y direction and a Z direction, further, one side of the X direction is set as X1, the other side of the X direction is set as X2, one side of the Y direction is set as Y1, the other side of the Y direction is set as Y2, one side of the Z direction is set as Z1, the other side of the Z direction is set as Z2, moreover, the Z direction corresponds to the upper and lower direction during actual use, and the Z1 direction corresponds to the upper side during actual use.

### (The Overall Structure of the Air Door Device)

As shown in FIG. 1, FIG. 5, FIG. 6 and FIG. 7, the air door device 1 includes: a frame 11, wherein the frame 11 is provided with an opening portion; a door panel 12, wherein the door panel 12 can rotate to open and close the opening portion 11 of the frame 11; a cover portion 21, wherein the cover portion 21 is assembled on the frame 11 along a preset direction (the X direction in the shown example) in the horizontal direction with an opening 210 facing the frame 11; a motor 22, wherein the motor 22 is arranged in a storage space SP enclosed by the cover portion 21 and the frame 11 and is used for driving the door panel 12 to rotate; a substrate 23, wherein the substrate 23 is arranged in the storage space SP; and a first lead 241, wherein the first lead 241 is connected with the substrate 23; and furthermore, the thickness direction of the substrate 23 is consistent with the preset direction in the horizontal direction, the motor 22 is closer to the opening 210 than the substrate 23, and the first lead 241 is led out from the surface of the substrate 23 facing the opening 210.

Here, as shown in FIG. 5 to FIG. 8, the air door device 1 further includes: a gear transmission mechanism 25, wherein the gear transmission mechanism 25 transmits the driving force of the motor 22 to the door panel 12; a switch 26; and a switching mechanism 27, wherein the switching mechanism 27 is driven by a gear in the gear transmission mechanism 25 to switch the on-off state of the switch 26. Furthermore, as shown in FIG. 6 to FIG. 8, the air door device 1 further includes a second lead 242, and the second lead 242 is connected with the motor 22 by welding.

### (The Structure on the Frame Side)

As shown in FIG. 1 to FIG. 4, the frame 11 includes a lower plate 111 and a side plate 112. Furthermore, the lower plate 111 is arranged in such a way that its thickness direction is consistent with the Z direction, the lower plate has a substantially rectangular outer contour when observed along the Z direction, a rectangular opening portion is formed at the center of the lower plate 111, and a peripheral edge of the opening portion is provided with, for example, a heater 13 (it is frame-shaped in the shown example) made of copper foil. Furthermore, as shown in FIG. 1 to FIG. 5, the side plate 112 includes a first plate portion 1121, a second plate portion 1122, a third plate portion 1123 and a fourth plate portion 1124, wherein the first plate portion 1121 is arranged in such a way that its thickness direction is consistent with the X direction, and is provided with a though hole 11211 passing through along the X direction, the second plate portion 1122 is arranged on the X1 direction side of the first plate portion 1121 in such a way that its thickness direction is consistent with the Y direction, the third plate portion 1123 and the first plate portion 1121 are parallel to each other and are oppositely arranged on the X1 direction side of the first plate portion 1121 at an interval in the X direction, and the fourth plate portion 1124 and the second plate portion 1122 are parallel to each other and are oppositely arranged on the Y2 direction side of the second plate portion 1122 at an interval in the Y direction. Furthermore, the second plate portion 1122 and the fourth plate portion 1124 connect the first plate portion 1121 and the third plate portion 1123 with each other to form a cylindrical shape, and the peripheral edge of the lower plate 111 is connected with the end portions of the first plate portion 1121, the second plate portion 1122, the third plate portion 1123 and the fourth plate portion 1124 on the Z2 direction side.

In addition, as shown in FIG. 1 to FIG. 4, the frame 11 further includes a peripheral wall portion 113, and the peripheral wall portion 113 extends from the peripheral edge of the first plate portion 1121 toward the cover portion 21 and is connected with the cover portion 21 through a clamping structure. Furthermore, the peripheral wall portion 113 includes a first wall portion 1131, a second wall portion 1132, a third wall portion 1133 and a fourth wall portion 1134, wherein the first wall portion 1131 is arranged in such a way that its thickness direction is consistent with the Y direction, and extends from the edge of the first plate portion 1121 on the Y1 direction side toward the X2 direction side, the second wall portion 1132 is arranged in such a way that its thickness direction is consistent with the Z direction, and extends from the edge of the first plate portion 1121 on the Z2 direction side toward the X2 direction side, the third wall portion 1133 and the first wall portion 1131 are parallel to each other and are oppositely arranged on the Y2 direction side of the first wall portion 1131 at an interval in the Y direction, and the fourth wall portion 1134 and the second wall portion 1132 are parallel to each other and are oppositely arranged on the Z1 direction side of the second wall portion 1132 at an interval in the Z direction. Furthermore, the second wall portion 1132 and the fourth wall portion 1134 connect the first wall portion 1131 and the third wall portion 1133 with each other to form a cylindrical shape.

Here, in the frame 11, the portion closer to the X1 direction side than the first plate portion 1121 constitutes a frame main body, the first plate portion 1121 and the peripheral wall portion 113 constitute a separation portion, and the separation portion is located between the frame main body and the cover portion 21, and encloses the storage space SP together with the cover portion 21. Furthermore, a guide groove is arranged on the outer surface of the separation portion. Specifically, a first guide groove 11212 is arranged on the surface of the separation portion facing the opening portion of the frame 11, the surface of the separation portion facing the Z1 direction side is provided with a second guide groove 11341 communicating with the first guide groove 11212 at one end, and the surface of the separation portion facing the Y2 direction side is provided with a third guide groove 11331 communicating with the other end of the second guide groove 11341. Furthermore, as shown in FIG. 2, a third lead 243 connected with a bonding pad portion of the heater 13 to supply power to the heater 13 is guided from the heater 13 toward the cover portion 21 side through the first guide groove 11212, the second guide groove 11341 and the third guide groove 11331 in sequence, so as to converge with the first lead 241 and the second lead 242.

### (The Structure of the Door Panel)

As shown in FIG. 1 to FIG. 6, the door panel 12 is substantially cuboid, and is provided with a door panel frame 121 and a plate-shaped portion 122. Furthermore, the door panel frame 121 has a rectangular frame shape and is provided with a central opening, and the plate-shaped portion 122 is arranged in the central opening of the door panel frame 121. Further, as shown in FIG. 5 and FIG. 6, a first pivot shaft portion 1211 and a second pivot shaft portion 1212 are arranged on the door panel frame 121, and the first pivot shaft portion 1211 and the second pivot shaft portion 1212 extend along the X direction, and are respectively arranged on both sides of the door panel frame 121 in the X direction (in the shown example, the first pivot shaft portion 1211 and the second pivot shaft portion 1212 are arranged on the edge of the door panel frame 121 on the Y1 direction side, but it is not limited thereto). Furthermore, the side of the plate-shaped portion 122 facing the lower plate 111 is made of, for example, an elastic material such as sponge.

### (The Structure of the Cover Portion)

As shown in FIG. 1 to FIG. 4, the cover portion 21 includes: a bottom wall 211, wherein the side of the bottom wall 211 away from the opening 210 in the preset direction in the horizontal direction is opposite to the frame 11 at an interval; and a peripheral wall 212, wherein the peripheral wall 212 extends from the peripheral edge of the bottom wall 211 toward the frame 11. Furthermore, the peripheral wall portion 212 includes a first wall portion 2121, a second wall portion 2122, a third wall portion 2123 and a fourth wall portion 2124, wherein the first wall portion 2121 is arranged in such a way that its thickness direction is consistent with the Y direction, and extends from the edge of the bottom wall 211 on the Y1 direction side toward the X1 direction side, the second wall portion 2122 is arranged in such a way that its thickness direction is consistent with the Z direction, and extends from the edge of the bottom wall 211 on the Z2 direction side toward the X1 direction side, the third wall portion 2123 and the first wall portion 2121 are parallel to each other and are oppositely arranged on the Y2 direction side of the first wall portion 2121 at an interval in the Y direction, and the fourth wall portion 2124 and the second wall portion 2122 are parallel to each other and are oppositely arranged on the Z1 direction side of the second wall portion 2122 at an interval in the Z direction. Furthermore, the second wall portion 2122 and the fourth wall portion 2124 connect the first wall portion 2121 and the third wall portion 2123 with each other to form a cylindrical shape.

Here, as shown in FIG. 6 to FIG. 8, the third wall portion 2123 (equivalent to the side wall in the embodiment of the present invention) is provided with an open pore 21231, the fourth wall portion 2124 (equivalent to the upper wall in the embodiment of the present invention) is provided with a shielding portion 21241, and the shielding portion 21241 is provided with a protrusion portion protruding along the horizontal direction (the Y direction in the shown example) from the vicinity right above the open pore 21231, and a bending portion extending downward (the Z2 direction in the shown example) from the front end of the protrusion portion. Furthermore, the open pore 21231 is arranged at the upper end of the third wall portion 2123. Furthermore, the third wall portion 2123 is further provided with a step portion 21232, and the step portion 21232 protrudes along the horizontal direction (the Y direction in the shown example) in the vicinity direct below the open pore 21231.

In addition, as shown in FIG. 6 to FIG. 8, the first lead 241 is connected with the substrate 23 (specifically, the surface of the substrate 23 facing the frame 11) by welding and is led out from the substrate 23 to the outside the storage space SP through the open pore 21231 of the cover portion 21, the second lead 242 is connected with the terminal of the motor 22 by welding and is led out from the motor 22 to the outside of the storage space SP through the open pore 21231 of the cover portion 21, and the third lead 243 is connected with the bonding pad portion of the heater 13 located on the X2 direction side of the opening portion of the frame 11, and is led out from the heater 13 to the step portion 21232 of the cover portion 21 through the first guide groove 11212, the second guide groove 11341 and the third guide groove 11331 in sequence, so as to converge with the first lead 241 and the second lead 242, and then the third lead is led out together with the first lead 241 and the second lead 242 (led out along the horizontal direction in the shown example, but it is not limited to thereto).

### (The Structure of the Motor)

As shown in FIG. 6 to FIG. 8, the motor 22 is provided with an output shaft 221, and a pinion 222 is arranged at the end portion of the output shaft 221 protruding from the shell of the motor 22.

Here, the motor 22 is a stepping motor. Further, the motor 22 includes a stator and a rotor that rotates with respect to the stator and has the output shaft 221, and the motor is provided with a terminal connected with the first lead 241 by welding. Further, the motor 22 is located on one side of the opening 210 of the cover portion 21 relative to the substrate 23, and is located between the substrate 23 and the third wall portion 2123 (that is, the motor 22 and the substrate 23 do not overlap in the X direction), and the output shaft 221 extends along the X direction. Further, electric power or a control signal can be provided for the motor 22 through the second lead 242.

### (The Structure of the Gear Transmission Mechanism)

As shown in FIG. 5 to FIG. 8, the gear transmission mechanism 25 includes a first gear 251, a second gear 252, a third gear 253, a fourth gear 254 and a fifth gear 255, which are engaged in sequence, wherein the first gear 251 at the most upstream is engaged with the pinion 222 arranged on the output shaft 221 of the motor 22, and the fifth gear 255 at the most downstream is coaxially connected with the door panel 12 through a shaft portion 2551 that penetrates through the through hole 11211 of the first plate portion 1121 (the fifth gear is connected with the first pivot shaft portion 1211 through a clamping structure in the shown example).

Here, the gear transmission mechanism 25 is a reduction gear train. Further, the rotation axes of the first gear 251, the second gear 252, the third gear 253, the fourth gear 254 and the fifth gear 255 are respectively parallel to the X direction, wherein the first gear 251, the second gear 252 and the third gear 253 are compound gears provided with large-diameter gear portions and small-diameter gear portions arranged along the X direction, the fourth gear 254 is provided with a large-diameter sector gear portion engaged with the third gear 253 and a small-diameter sector gear portion engaged with the fifth gear 255 and located on the X1 direction side of the large-diameter sector gear portion, and the fifth gear 255 is a sector gear. Furthermore, the fourth gear 254 is provided with a first pressing portion and a second pressing portion arranged in the circumferential direction around the rotation axis of the fourth gear, and the first pressing portion and the second pressing portion are located on one side opposite to the small-diameter sector gear portion with respect to the large-diameter sector gear portion. Further, the gear transmission mechanism 25 is located on one side of the opening 210 of the cover portion 21 with respect to the substrate 23.

### (The Structure of the Substrate)

The substrate 23 is a single-sided substrate.

Here, as shown in FIG. 7, the substrate 23 is arranged on the side of the fourth wall portion 2124 in the cover portion 21 and is arranged on the side of the first wall portion 2121.

### (The Structure of the Switch)

The switch 26 is a button switch, and is provided with a button that can move along the Y direction by pressing.

In addition, as shown in FIG. 6 to FIG. 8, the switch 26 is installed on the surface of the substrate 23 facing the opening 210, and the terminal of the switch 26 is welded on the substrate 23. An on-off signal of the switch 26 can be output to the outside through the first lead 241.

### (The Structure of the Switching Mechanism)

As shown in FIG. 6 to FIG. 8, the switching mechanism 27 includes a rotating component 271 and a force application component 272, wherein the rotation axis of the rotating component 271 is parallel to the X direction, the rotating component is provided with a first abutting portion 2711 and a second abutting portion 2712 arranged in the circumferential direction around the rotation axis of the rotating component, the force application component 272 applies a force to the rotating component 271, so that the rotating component 271 applies a force toward a direction where the first abutting portion 2711 abuts against the switch 26 and the switch 26 is turned on. Further, the four gear 254 can cause the first pressing portion to abut against the second abutting portion 2712 by rotating, so that the rotating component 271 rotates toward a direction where the first abutting portion 2711 departs from the switch 26 and the switch 26 is turned off, or, the four gear causes the second pressing portion to abut against the second abutting portion 2712, so that the rotating component 271 rotates toward a direction where the first abutting portion 2711 departs from the switch 26 and the switch 26 is turned off. In this way, the on-off state of the switch is switched.

Here, the rotating component 271 is provided with a shaft portion coaxial with its rotation axis, and a first arm portion and a second arm portion, which extend radially outward from the shaft portion, the front end of the first arm portion is provided with the first abutting portion 2711, and the front end of the second arm portion is provided with the second abutting portion 2712; and the force application component 272 is a coil spring, one end of which abuts against the cover portion 21, and the other end of which abuts against the rotating component 271. Furthermore, the switching mechanism 27 is located on one side of the opening 210 of the cover portion 21 with respect to the substrate 23.

(The Main Effects of this Embodiment)

According to the air door device 1 of the this embodiment, the thickness direction of the substrate 23 is consistent with the preset direction in the horizontal direction, the motor 22 is closer to the opening 210 than the substrate 23, and the first lead 241 is led out from the surface of the substrate 23 facing the opening 210 (that is, the surface facing the frame 11). Therefore, the first lead 241 is easily threaded, and the first lead 241 can be threaded after the motor 22, the substrate 23 and the first lead 241 are assembled in the cover portion 21, so the assembly operation is easy. Furthermore, the creepage distance can be increased to avoid water from intruding into the storage space SP through the gap between the cover portion 21 and the frame 11 to reach the substrate 23, resulting in the dielectric breakdown of the substrate 23.

In addition, according to the air door device 1 of the this embodiment, the first lead 241 is led out from the substrate 23 to the outside of the storage space SP through the open pore 21231 of the cover portion 21, and the open pore 21231 is arranged at the position beyond the fourth wall portion 2124 of the cover portion 21. Therefore, it is conducive to preventing water from intruding into the storage space SP from the open pore 21231 of the cover portion 21 along the first lead 241 to reach the substrate 23, resulting in the dielectric breakdown of the substrate 23.

The embodiment of the present invention is exemplarily described above in conjunction with the drawings. Obviously, the specific implementation of the embodiment of the present invention is not limited by the above-mentioned embodiment.

For example, in the above-mentioned embodiment, the air door device 1 further includes the second lead 242, the second lead 242 is connected with the terminal of the motor 22, but it is not limited to thereto, and the terminal of the motor 22 can also be connected with the substrate 23 by welding.

In addition, in the above-mentioned embodiment, the open pore 21231 is arranged at the upper end of the third wall portion 2123, but it is not limited to thereto, the open pore 21231 can also be arranged at other positions of the third wall portion 2123, and can also be arranged on the bottom wall 211, the first wall portion 2121 or the second wall portion 2122. In this case, the positions of the shielding portion 21241 and the step portion 21232 can be adjusted appropriately.

In addition, in the above-mentioned embodiment, the cover portion 21 is provided with the shielding portion 21241, but it is not limited to thereto, and the shielding portion 21241 can also be not provided according to circumstances.

In addition, in the above-mentioned embodiment, the cover portion 21 is provided with the step portion 21232, but it is not limited to thereto, and the step portion 21232 can also be not provided according to circumstances.

In addition, in the above-mentioned embodiment, the frame 11 further includes the peripheral wall portion 113, the peripheral wall portion 113 extends from the peripheral edge of the first plate portion 1121 toward the cover portion 21 and is connected with the cover portion 21 through the clamping structure, but it is not limited thereto, the peripheral wall portion 113 can also be omitted according to circumstances, and the cover portion 21 is directly connected with the first plate portion 1121 to form the storage space SP.

In addition, in the above-mentioned embodiment, the heater 13 is arranged on the periphery of the opening portion of the frame 11, but it is not limited to thereto, and the heater 13 can also be arranged on the door panel 12.

In addition, in the above-mentioned embodiment, the heater 13 and the third lead 243 connected with the heater 13 are provided, but it is not limited to thereto, and the heater 13 and the third lead 243 can also be not provided according to circumstances.

In addition, in the above-mentioned embodiment, the substrate 23 is the single-sided substrate, but it is not limited to thereto, and the substrate 23 can also be a double-sided substrate.

In addition, in the above-mentioned embodiment, the motor 22 is located between the substrate 23 and the third wall portion 2123, that is, the motor 22 does not overlap with the substrate 23 in the X direction, but it is not limited to thereto, and the motor 22 can also overlap with the substrate 23 in the X direction.

In addition, in the above-mentioned embodiment, the frame 11 is provided with the first guide groove 11212, the second guide groove 11341 and the third guide groove 11331 for guiding the third lead 243, but it is not limited to thereto, only one or two of the first guide groove 11212, the second guide groove 11341 and the third guide groove 11331 are provided, and the first guide groove 11212, the second guide groove 11341 and the third guide groove 11331 can also be omitted according to circumstances.

It should be understood that within the scope of the embodiments of the present invention, various parts in the embodiment can be freely combined, or various parts in the embodiment can be appropriately deformed or omitted.

What is claimed is:

1. An air door device, comprising: a frame, wherein the frame is provided with an opening portion; a door panel, wherein the door panel can rotate to open and close the opening portion; a cover portion, wherein the cover portion is assembled on the frame along a preset direction in the horizontal direction with an opening facing the frame; a motor, wherein the motor is arranged in a storage space enclosed by the cover portion and the frame and is used for driving the door panel to rotate; a substrate, wherein the substrate is arranged in the storage space; and a first lead, wherein the first lead is connected with the substrate, wherein,
the thickness direction of the substrate is consistent with the preset direction,
the motor is closer to the opening than the substrate, and
the first lead is led out from the surface of the substrate facing the opening.

2. The air door device of claim 1, wherein,
the first lead is led out from the substrate to the outside of the storage space through an open pore of the cover portion, and
the open pore is arranged at a position beyond an upper wall of the cover portion.

3. The air door device of claim 2, wherein,
the air door device comprises a second lead, and
the second lead is connected with the terminal of the motor and is led out from the motor to the outside of the storage space through the open pore.

4. The air door device of claim 3, wherein,
the cover portion comprises:
a bottom wall, wherein the bottom wall is opposite to the frame at an interval on one side away from the opening in the preset direction;
the upper wall, wherein the upper wall extends from the bottom wall toward the frame; and
a side wall, wherein the side wall extends from the bottom wall toward the frame,
the side wall is provided with the open pore,
one of the upper wall and the side wall is provided with a shielding portion, and
the shielding portion is provided with a protrusion portion protruding along the horizontal direction from the vicinity right above the open pore,
or is further provided with a bending portion extending downward from the front end of the protrusion portion.

5. The air door device of claim 4, wherein,
the upper wall is provided with the shielding portion, and
the open pore is arranged at the upper end of the side wall.

6. The air door device of claim 4, wherein,
the side wall is provided with a step portion, and
the step portion protrudes along the horizontal direction in the vicinity direct below the open pore.

7. The air door device of claim 6, comprising:
a heater, wherein the heater is arranged on the periphery of the opening portion or on the door panel; and
a third lead, wherein the third lead is connected with the heater and is led out from the heater to the step portion to converge with the first lead and the second lead, and then is led out together with the first lead and the second lead.

8. The air door device of claim 7, wherein,
the frame is provided with a frame main body and a separation portion,
the frame main body is provided with the opening portion,
the separation portion is located between the frame main body and the cover portion and encloses the storage space together with the cover portion,
a guide groove is arranged on the outer surface of the separation portion, and
the third lead is guided from the heater to the step portion through the guide groove.

9. The air door device of claim 4, wherein,
the substrate is a single-sided substrate and is arranged on the upper wall side of the cover portion,
the motor is located between the substrate and the side wall, and
the first lead is welded on the surface of the substrate facing the opening.

10. The air door device of claim 1, comprising:
a gear transmission mechanism, wherein the gear transmission mechanism transmits the driving force of the motor to the door panel and is closer to the opening than the substrate;
a switch, wherein the switch is installed on the surface of the substrate facing the opening; and
a switching mechanism, wherein the switching mechanism is driven by a gear in the gear transmission mechanism to switch the on-off state of the switch.
